(19) United States
(12) Patent Application Publication
(10) Pub. No.: US 2018/0351334 A1
(43) Pub. Date: Dec. 6, 2018

(54) ARTICULATED IONISATION DEVICE

(71) Applicant: WAKEUP MANAGEMENT PTY LIMITED, Vaucluse (AU)

(72) Inventor: James HARRISON, Vaucluse (AU)

(21) Appl. No.: 15/778,875

(22) PCT Filed: Nov. 23, 2016
(86) PCT No.: PCT/AU2016/051150

§ 371 Date: May 24, 2018

(30) Foreign Application Priority Data
Nov. 27, 2015 (AU) 2015261685

(51) Int. Cl. H01T 23/00; H01T 19/00

(52) U.S. Cl. CPC H01T 23/00; H01T 19/00

(57) ABSTRACT

The present invention provides an emitter assembly, comprising one or more emitter arms which extend from a main arm, each of the one or more emitter arms having at least a portion having a cross section which has a major axis and a minor axis, the major axis lying in a horizontal plane in use and the minor axis being in a vertical plane in use. The present invention further provides an ionization device or installations, comprising an emitter assembly as described above; a mast which supports the emitter assembly; and a raising apparatus which raises the mast to an upright position in articulated stages.

### FIELD OF THE INVENTION

The present invention relates to ionisation devices and installations. In particular the present invention relates to an apparatus for erecting an ionisation device, an ionisation installation and an emitter assembly in an ionisation device.

### BACKGROUND OF THE INVENTION

An air ionization device can be used to trigger a local change in weather. The device has a high voltage line for generating a corona discharge from an emitter. Generally the emitter is located on a structure such as a mast, so as to be located above ground level, to more effectively ionise particles in the air in the vicinity of moisture containing clouds. Ineffective emitters will reduce the amount corona discharge produced or emitted, or allow a high proportion of ions to go to earth. Use of an ionisation device therefore involves providing a tall structure with a lower field wire. The height of the ionisation device also makes it difficult for servicing or repair work to be done to the emitter assembly, in addition to making the device vulnerable to wind loading.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention provides an emitter assembly, comprising one or more emitter arms which extend from a main arm, each of the one or more emitter arms having at least a portion having a cross section which has a major axis and a minor axis, the major axis lying in a horizontal plane in use and the minor axis being in a vertical plane in use.

The one or more emitter arms can extend generally horizontally in use.

The portion has a cross section of one of the following shapes: aerofoil, “D”, tear drop.

There can be a helical winding around the at least portion.

The helical winding can comprise a plurality of strands of fibres which are bunched together.

The fibres can be stainless steel fibres.

The fibres can be each between approximately 6 and 12 microns in diameter.

The helical winding can be wound around the one or more emitter arms at approximately 50 to 100 millimetre centres.

There can be two emitter arms which extend in diametrically opposing directions from each other.

There can be a pair of horizontal field arms which extend from the main arm, in diametrically opposing directions from each.

There can be field wires running along the field arms.

There can be horizontal support brackets extending from the main arm, and horizontal stabilising lines which run from free tips of the emitter arms to the horizontal support brackets.

The present invention further provides an ionization device or installations, comprising an emitter assembly as described above; a mast which supports the emitter assembly; and a raising apparatus which raises the mast to an upright position in articulated stages, the raising apparatus being an apparatus as described in the paragraphs above.

At least a section of the mast can have a cross section of one of the following shapes: aerofoil, “D”, tear drop.

The one or more emitter arms of the emitter assembly can be pivotable relative to the mast.

The one or more emitter arms of the emitter assembly can be detachable from the mast.

The present invention further provides a method of erecting an ionisation device which includes an emitter array supported by a mast, comprising: fixing a first support on a base or the ground; raising an intermediate support so that it pivots about a first pivot connection with the first support, until the intermediate support is in a substantially upright position; pivoting the mast about a second pivot connection connecting the intermediate support and the mast.

The intermediate post can be aligned with the first support when it is in a substantially upright position.

The method can include the step of securing a brace, which is connected to the mast, to a second support located adjacent the first support.

The brace can be attached to the mast at the second pivot connection, and is provided at a fixed angle relative to the intermediate support.

The present invention also provides an apparatus for erecting a mast, comprising: a first support that is supported on a base; an intermediate post that is pivotable relative to the first support at a first pivot, the first pivot being located at or near a first end of the intermediate support; the mast being pivotably supported by the intermediate post at a second pivot, the second pivot being located in a lower or intermediate portion of the mast when the mast is in a substantially upright position.

The apparatus can have two of the first supports and two of the intermediate supports, wherein one first support and one intermediate support are placed on one side of the mast, and the other first support and intermediate support are placed on an opposing side of the mast.

An apparatus as claimed in claim 1, wherein the first support includes a yoke which supports the mast.

The apparatus can have a second support located adjacent the first support; the second support supporting an arrangement for raising the intermediate post at the first pivot.

The second support can include a yoke.

The arrangement for raising the intermediate post can be a first winch means.

The second support can support an arrangement for pivoting the mast about the second pivot.

The arrangement for pivoting the mast about the second pivot can be a second winch means.

The arrangement for pivoting the intermediate support about the second pivot can include a connection to an end of the intermediate support that is located closest to the ground when the intermediate is raised to a substantially upright position.

The apparatus can further have a brace having one end that is attached to the mast, and an opposite end being adapted for connection with the second support, so that when the intermediate support is in a substantially upright position, the brace connects between the mast and the second support.

A pivot axis through the second pivot point can also extend through an attachment location of the brace to the mast, the mast or first support being pivotable relative to the brace.

The brace can be provided at a fixed angle to the intermediate support.

The apparatus can have an emitter assembly having one or more emitter arms, the emitter assembly being supported by the mast so that the emitter assembly is located atop the mast when the mast is in a substantially upright position.

The base can be one of the following: on a transportable base; a mobile base; on a rotating base; on a stationary base.

A field wire can be located at a 70% to 75% height from the base.

### BRIEF DESCRIPTION OF THE DRAWINGS

An embodiment or embodiments of the present invention will now be described, by way of example only, with reference to the accompanying drawings, in which:

FIG. 1 is a side elevation view of a trailer mounted ionisation installation and a raising apparatus for raising the ionisation device, the apparatus being in a first stage for raising the ionisation device;

FIG. 2 is a side elevation view of the installation depicted in FIG. 1, with the apparatus in a second stage for raising the ionisation device;

FIG. 3 is a front elevation view of the installation and supporting uprights of the raising device, supporting the mast and the emitter assembly in a substantially upright position;

FIG. 3A is a side elevation view of the apparatus depicted in FIG. 3 with the mast substantially upright and locked in position;

FIG. 4 is a partial perspective view of supporting uprights of another embodiment of the device support and raising system;

FIG. 5 is a partial perspective view of supporting uprights of a further embodiment of the raising device;

FIG. 6A is a partial front elevation view of the ionisation installation of previous figures;

FIG. 6B is a plan view of the ionisation installation, showing the emitter arms and horizontal stays;

FIG. 6C is an elevation view of a fitting arrangement for mounting to a mast top to receive emitter arms and two horizontal and one vertical bracing brackets;

FIG. 6D is an plan view of a fitting arrangement to receive field arms and forward and rearward horizontal bracing brackets;

FIG. 7 is a partial perspective view of an emitter arm of the ionisation array;

FIG. 8 is a schematic plan view of a trailer for transporting the ionisation installation and raising apparatus;

FIG. 9 is a schematic elevation view of a vehicle for transporting the ionisation device and raising apparatus;

FIG. 10 is a plan view of a rotating base for the emitter installation;

FIG. 11 is an cross sectional view of the rotating base shown in FIG. 10, through the line B-B;

FIG. 12 is an cross sectional view of the rotating base shown in FIG. 10, through the line A-A;

FIG. 13 is a plan view of an emitter assembly mounted on the rotating base shown in FIG. 10, showing by-directional rotation of the rotating plate;

FIG. 14 is a schematic elevation view of a raising and support apparatus which includes hydraulic means to raise the mast to an upright position;

FIG. 15 is a schematic elevation view of a telescoping mast;

FIG. 16 is a partial elevation view of an emitter assembly with emitter arms which fold toward the mast;

FIG. 17 depicts a plan view of the emitter assembly of FIGS. 10 and 13, mounted on a rotating plate on a trailer;

FIG. 18 illustrates a plan view of a raising and supporting apparatus and emitter assembly for a ground based version;

FIG. 19 illustrates a perspective view of the system or assembly of FIG. 18, showing a perspective view of the emitter assembly of previous figures; and

FIG. 20 illustrates a partial side view of the assembly of FIGS. 18 and 19, showing the anchoring of outriggers to a ground location.

### DETAILED DESCRIPTION OF THE EMBODIMENT OR EMBODIMENTS

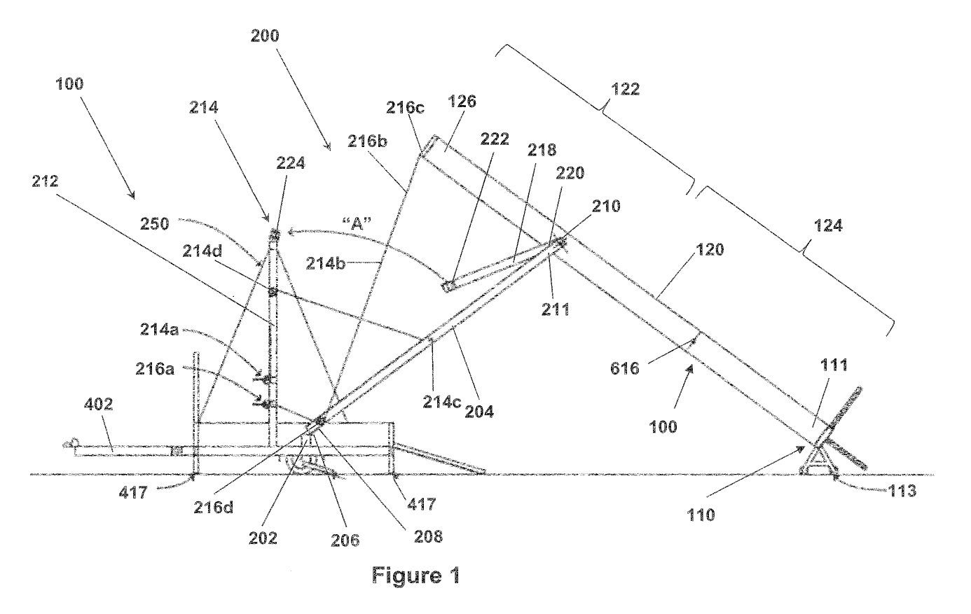

FIG. 1 depicts an ionisation installation 100, and an apparatus 200 for supporting and erecting the ionisation device of the installation. Positional references such as top and bottom will be used, to describe the various parts of the components of the ionisation device 100 and the raising apparatus 200, by the positions that they take when the ionisation installation 100 is upright and supported by the apparatus 200.

The ionisation installation 100 generally includes an emitter assembly 110 which is supported by a mast 120. The raising and support apparatus 200 raises the emitter assembly 100 to a substantially upright position. The emitter assembly 110 then produces and emits charged particles to the atmosphere.

The raising and support apparatus 200 can be ground supported, as discussed below in relation to FIGS. 18 to 20, or it can be supported on a fixed or movable base or platform. The apparatus 200 shown in FIG. 1 is supported by a movable platform 402, as part of or towed by a vehicle in the form of a trailer 400. The raising and support apparatus 200 includes a first upright or support 202 that is supported on the platform 402. The first upright or support 202 is hinged to and supports an intermediate post or support 204, at a first pivot or hinge 206. The pivot axis at the first pivot or hinge 206 passes through a first end, being the lower end 208 of the intermediate post or support 204 when it is raised to a substantially upright position. The first upright or support 202 is about 150 millimetres (mm) in height. As the first upright or support 202 is short in height, the first pivot or hinge 206 is located close to the ground or base. The intermediate post or support 204 is made from a square hollow section of steel to reduce weight. Another material with sufficient strength and a hollow cross section may be used. The intermediate post or support 204 is made from a glass reinforced plastic, and is about 4 metres in length, with a cross section of about 10 cm×10 cm in size.

The first pivotable connection 206, located between the intermediate post or support 204 and the first upright or support 202, allows the intermediate post or support 204 to be rotated to a horizontal or near horizontal orientation. The horizontal orientation of the intermediate post or support 204 facilitates transport by a vehicle. In some cases, and possibly most preferably, the intermediate post or support 204 can be detached from the first upright 202 for the purpose of transport.

The intermediate post or support 204 supports the columnar structure to be raised by the apparatus 200 in use. The mast 120 is in use pivoted or hinged to the intermediate post or support 204 at a second pivot or hinge 210. The pivot axis at the second pivot 210 generally passes through the intermediate post 204 at a top end 211 of the intermediate post or support 204. The mast 120 has a first end 126 that will be located nearest to the ground when the mast 120 is in a substantially upright position. For ease of reference the first end 126 will be referred to as the lower end. The pivot axis of the second pivot 210 passes through the mast 120 at a location that is in a lower or middle portion 122 of the mast 120, when the mast 120 is in a substantially upright position. It is generally closer to the lower end 126 than the opposite (i.e. top) end.

While the mast 120 is not yet raised to its upright position, the upper portion 124 of the mast 120 is permitted to fall toward the ground. This configuration allows the emitter assembly 110 to rest on the ground or a support 113 on the ground, for a technician or operator to access the emitter assembly 110 as required, for the purpose of adjusting, inspecting, or maintaining the emitter assembly 110, or for any other purposes. As an example, in a configuration where the mast is about 6 to 10 metres in total length, the second pivot is located at around 2 metres from the lower end of the mast.

The raising apparatus 200 further includes a second upright or support 212. The second upright or support 212 is generally made from a polymer such as a glass reinforced plastic. As an example, the second upright or support 212 has a length of about 2.5 metres and has a cross section of 10 cm×10 cm in size.

The second upright or support 212 is inserted directly into the ground or mounted to a ground support, or onto or into an appropriate mounting on a platform, whether moveable or stationary. Stabilising lines 250, which here are insulating or insulated cable riggings, which should have no conductive element in them and be made of low stretch insulating material, are provided to the top portion of the second upright or support 212. The stabilising lines 250 are tied to fittings on a support base 404 or the apparatus platform 402, or to fittings such as pegs which can be secured to the ground, to form a triangular support strut.

The second upright or support 212 is located adjacent the first upright or support 202, so that during the operation of the raising and support apparatus 200, the lower end 126 of the mast 120 rotates between the intermediate post or support 204 and the second upright or support 212. The second upright or support 212 supports mechanisms that enable the rotation of various parts of the raising apparatus, to erect the mask 120. These mechanisms are controllable at a height reachable by an operator standing on the ground or the platform on which the raising apparatus is supported. For example, the controls are provided at a height below 2 metres.

A first mechanism or arrangement 214 is provided for raising the intermediate post or support 204 at the first pivot 206 to a substantially upright position. The arrangement 214 for raising the intermediate post or support 204 includes a first winch 214a. The winch is a braked winch. The winch is the driving mechanism 214a for the first arrangement 214. The controls for the driving mechanism 214a are located at a vertical height that is accessible by an operator, e.g. at below 2 metres. The first arrangement 214 includes a cable or belt or rope 214b which is fixed to the intermediate post or support 204 at an attachment location 214c. The attachment location 214c is high enough, i.e. far away enough from the first pivot 206, to allow a lever arm of a sufficient length, to efficiently rotate the intermediate post or support 204. However the attachment location 214c is also preferably located low enough for easy access by an operator. In the depicted example the attachment location of the cable 214b is at around 2 metres in height.

The driving mechanism 214a is as mentioned above a winch, or other mechanical, electro-mechanical, or hydraulic drive, to raise the intermediate post 204 by driving the cable or rope 214b, which pulls on the intermediate post or support 204 at the attachment location 214c. If required, an intervening gear, sheave or pulley 214d is provided on the second upright or support 212, at a height corresponding or close to that of the attachment location 214c. The cable or belt 214b passes over the intervening gear or pulley 214d. The cable 214b is held in tension between the driving mechanism 214a, the intervening gear or pulley 214d, and the fixed attachment point 214c. Driving the cable 214b in a first direction raises the intermediate post or support 204. Releasing the cable 214b in a reverse direction lowers the intermediate post or support 204. A single winch can be used to raise both columns.

The mast 120 is first mounted or pivoted to the intermediate post or support 204, after which an operator can use the first arrangement 214 to raise the intermediate post or support 204 until it is substantially upright. The raising of the intermediate post or support 204 to its upright position is the first stage of the process of erecting the ionisation installation 100. The rotational movement of the system, showing the intermediate post or support 204 being raised to its upright position, is shown by arrow “A” in FIG. 1.

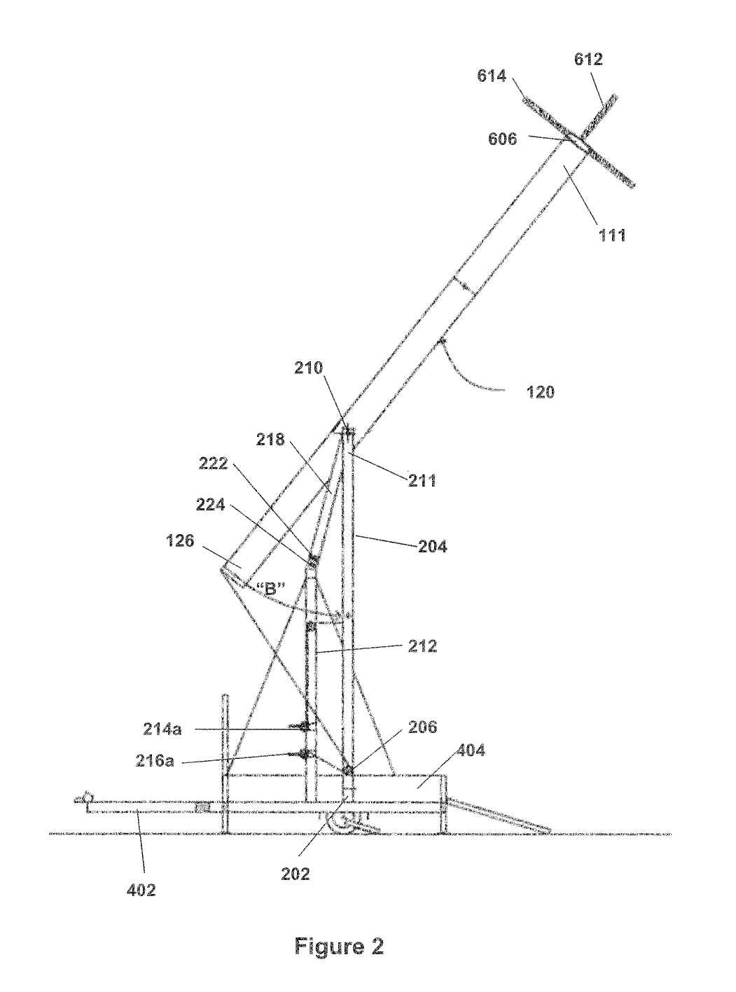

Referring to both FIGS. 1 and 2, a second arrangement 216 is also located on the second upright or support 212. The second arrangement 216 will come into operation after the first stage of the raising operation is completed. The second arrangement 216 in use rotates the mast 120 about the second pivot 210, so as to raise it to a substantially upright position in a second stage of raising the ionisation installation. The second arrangement 216 includes second winch 216a, or another mechanical, electro-mechanical or hydraulic driving mechanism. The second driving mechanism 216a drives a cable or rope 216b. The controls for the driving mechanism 216a are located at a vertical height that is accessible by an operator, e.g. at below 2 metres

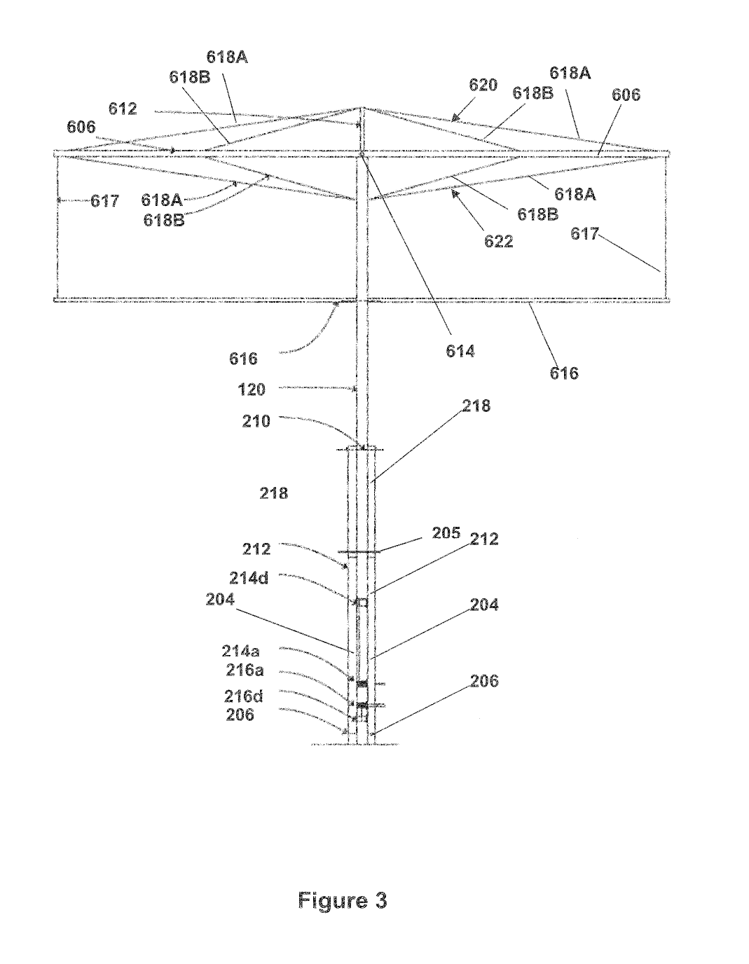

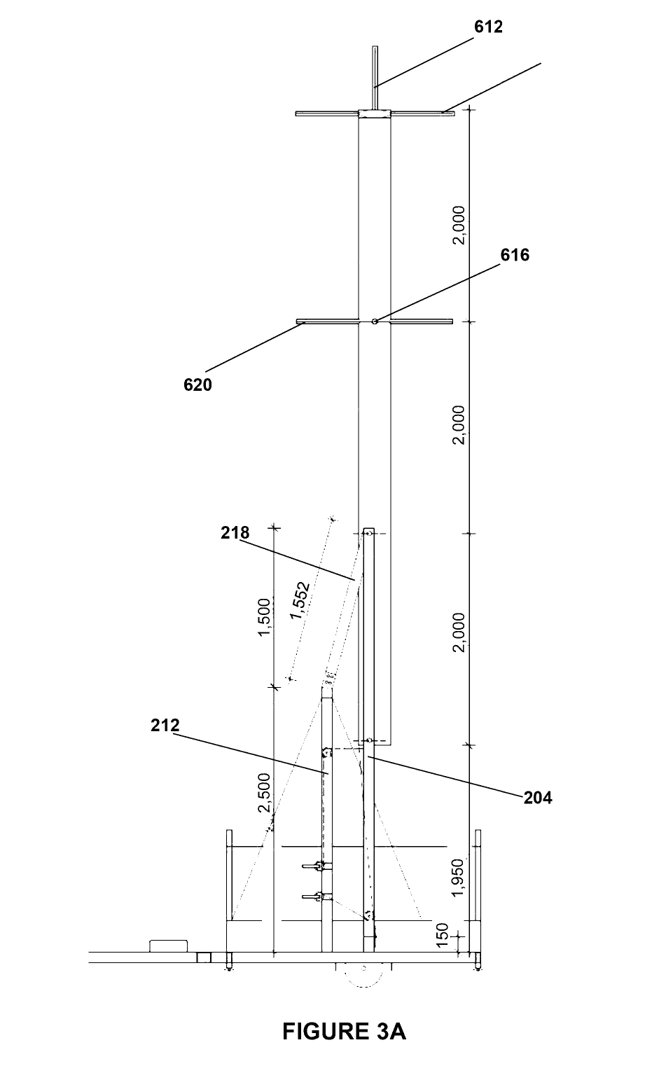

The rope or cable 216b is also fixed to a part of the mast 120 that is located close to the ground when the mast 120 is in an upright position, e.g. at a height of around 2 metres. In the depicted example the fixed connection 216c of the cable 216b to the mast 120 is located at the lower end 126 of the mast 120. The belt or cable 216b passes over an intervening pulley, sheave or gear 216d located on the intermediate post or support 204. The intervening pulley or gear 216d is located close to the lower end 208 of the intermediate post or support 204. The cable 216b is held in tension between the driving mechanism 216a, the intervening gear or pulley 216d, and the fixed attachment point 216c. Pulling the cable 216b in one direction pulls the near end of the mast 120 downwards, rotating the mast 120 toward the second upright or support 212. Releasing the cable 216b, allows movement in a reverse direction to lower the mast 120. The rotational movement of the system, showing the mast 120 being rotated to its upright position, is shown by arrow “B” in FIG. 2. At the end of the stage 2 movement, the mast 120 is upright (as shown in FIG. 3) and from side view is aligned with the intermediate post or support 204. Once in this position the base of the mast 120, below pivot 210, can be pinned or otherwise secured to the base, trailer or intermediate post or support 104.

As shown in FIGS. 1 and 2, there is a brace 218 attached to the intermediate post or support 204. For example, the brace 218 is about 1.5 metres in length.

A first end 220 of the brace 218 is attached to the second pivot 210. The mast 120 is pivotable relative to the brace 218, but the brace 218 is fixed in relation to the intermediate post or support 204. Alternatively, the brace 218 can be fixed to the intermediate post or support 204 directly. The first end 220 of the brace 218 is attached at a fixed angle in relation to the intermediate post or support 204. The opposite end 222 of the brace 218 is adapted for connection with the second upright post or support 212, which is shorter in height than the intermediate post or support 204. The opposite end 222 is therefore located lower than the first end 220. The length of the brace 218, and its angle relative to the intermediate post or support 204 are chosen so that when the intermediate post or support 204 is in a substantially upright position, the brace 218 connects with a brace receiving part 224 on the second upright or support 212, as depicted in FIG. 2. The brace 218 receiving part 224 is angled with respect to the remainder of the second upright or support 212, to complement the angle of the brace 218. A locking pin can be inserted through the brace receiving part 224 and the brace 218 to secure these components together, or they can be secured together in another appropriate manner. The brace 218 thereby provides some lateral support against further movements of the intermediate post or support 204, which can occur in windy conditions.

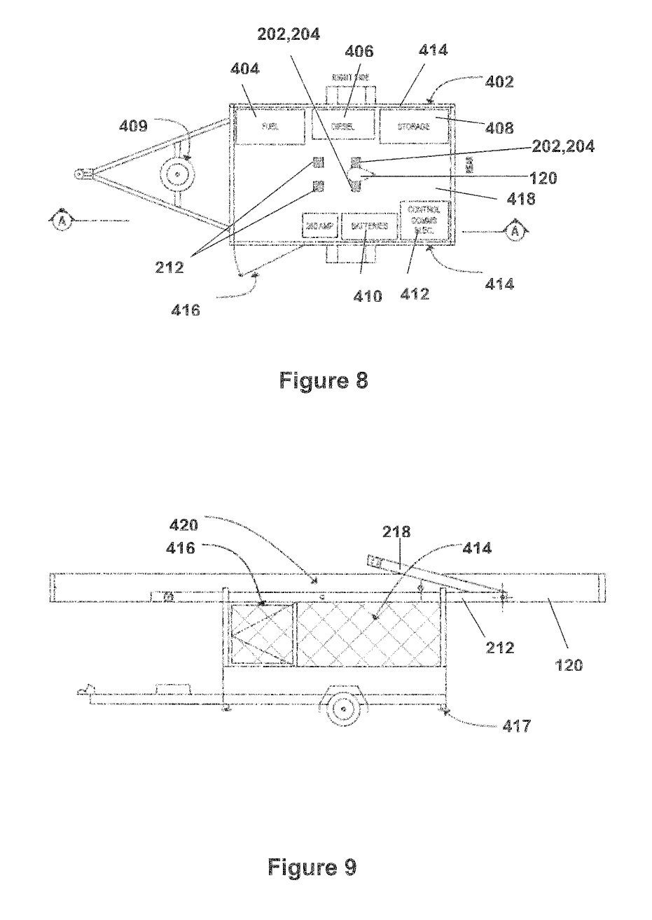

As shown in FIGS. 3 and 8, a pair of intermediate posts or supports 204 are provided (they are labelled in FIG. 3 but are located behind the second upright or support 212 and braces 218), so that they are located on opposite sides of the mast 120. Similarly, a pair of second uprights or supports 212 can be provided, each to align with a respective intermediate post or support 204, to connect with the braces 218 attached to the intermediate posts or supports 204.

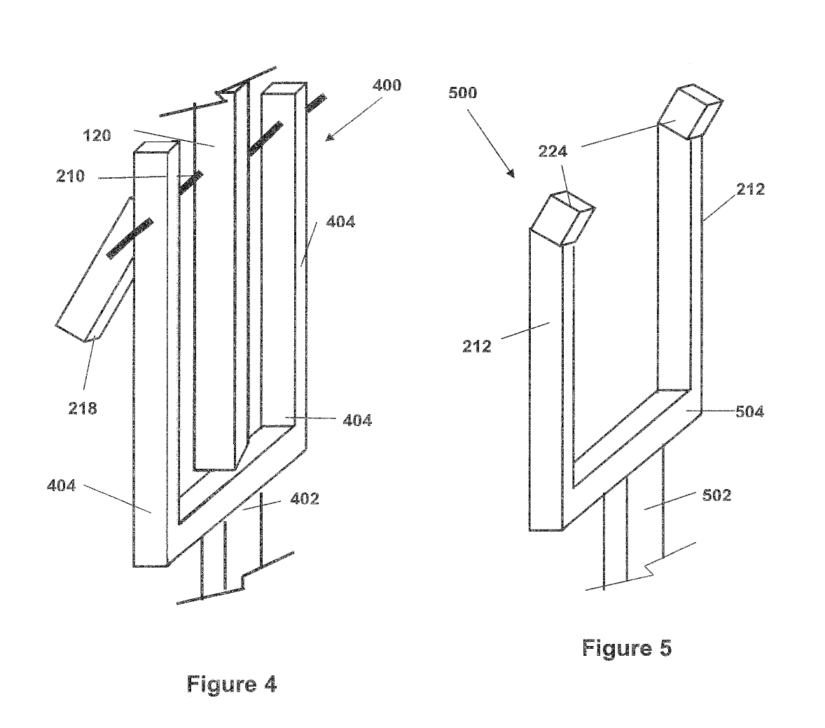

As shown in FIG. 4, the pair of intermediate posts or supports 404 can be provided as parts of a yoke 400. The yoke 400 includes a single support leg or post 402 which is hinged to the base. The support leg 402 supports a cross piece 404, the ends of which are connected to a pair of yoke arms 404. The yoke arms 404 are pivotably attached to the mast 120 at the second pivot 210, and function as a pair of opposite intermediate posts as described above.

As shown in FIG. 5, the pair of second uprights or supports 212 can similarly be included in a yoke 500. The yoke 500 includes a single support leg or post 502 which at its lower end is secured to the base or trailer supports a horizontal cross piece 504. A pair of yoke arms 212 extend upwardly from the ends of the cross piece 504, each ending in a bent portion 224. The vertical arms 212 function as the second uprights or supports 212 as described above, and the bent portions 224 function as the brace receiving parts 224 as described above.

Combinations of the previously described supports or supports and yokes can be used. For instance, the intermediate posts can be part of a yoke arrangement as shown in FIG. 4, while a pair of second uprights are ground or platform supported can be used. Alternatively, the pair of second uprights can be part of a yoke arrangement as shown in FIG. 5, while a pair of intermediate posts and respective first uprights can be provided. Alternatively, the intermediate posts can be part of a yoke arrangement as shown in FIG. 4, while the pair of second uprights can also be parts of a yoke arrangement as shown in FIG. 5 to provide a raising and supporting system.

The articulated operation of the raising apparatus is now discussed with reference to FIGS. 1 and 2. After transport, the raising and support apparatus 200 is first set up so that the first uprights or supports 202 and second uprights or supports 212 are in their respective upright positions. The intermediate posts or supports 204 are hinged to the first uprights or supports 202 either on site, or prior to arrival. The mast 120 is hinged to the intermediate posts or supports 204 on site. Or, if the trailer is of sufficient length, the mast can be connected to the support 204 prior to arrival. The top end 211 of the intermediate posts or supports 204 either left on the ground or raised to an intermediate angle (as shown in FIG. 1). The mast 120 is also ground supported or supported by a stand, a ‘dolly’, or a ‘sammy’ 113 at its end 111 which will be the top end when the mast 120 is upright. The stand 113 includes wheels or may have skid base. Any maintenance or tuning, or any other work which requires access to the emitter assembly (or anything that is supported by the mast to be raised) is performed.

In a first stage of the articulated operation, the first raising mechanism or arrangement 214 is operated to raise the intermediate posts or supports 204 up to a substantially upright position. In embodiments where a brace 218 is provided, at the completion of stage 1, the braces 218 are connected to the brace receiving portions 224 on the second uprights 212. At the end of stage 1, the first uprights or supports 202, the intermediate posts or supports 204, the second uprights or supports 212 and the braces 218 take the positions shown in FIG. 2.

In a second stage of the articulated operation, the second raising mechanism or arrangement 216 is then operated to rotate the mast 120 up to its substantially upright position, in the direction marked by arrow “B” in FIG. 2. At the completion of the second stage, the mast 120 is substantially upright, as shown in FIG. 3A. The lower end 126 of the mast 120 is secured to the intermediate post 204 at a lock position 205 using, e.g. a locking pin or clamp, to lock the mast 120 in the substantially upright position. The emitter assembly 110 can then be powered to commence operation of the ionisation device. The lock position 205 is located at a height of about 2.5 metres, or at a suitable height accessible by an operator.

FIG. 3A further depicts a lower set of horizontal brackets 620, extending below the top set of horizontal brackets 614. These allow horizontal stays 619 to be tethered to the field arms 616 to stabilise the field arms 616.

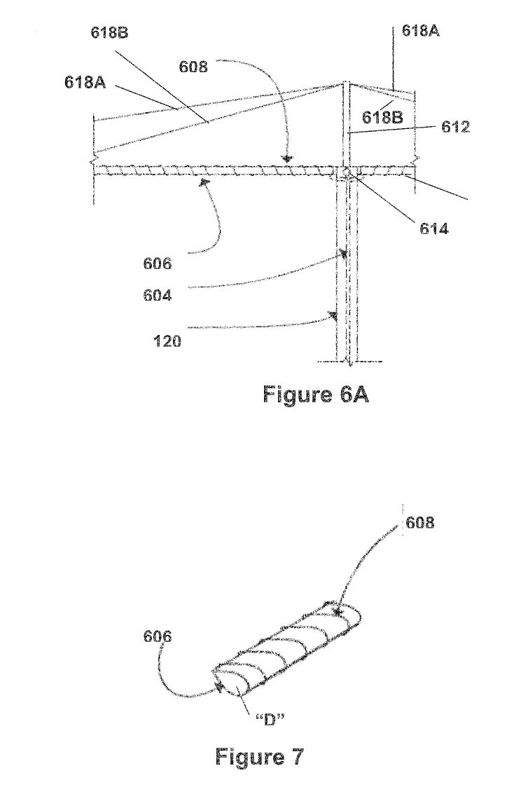

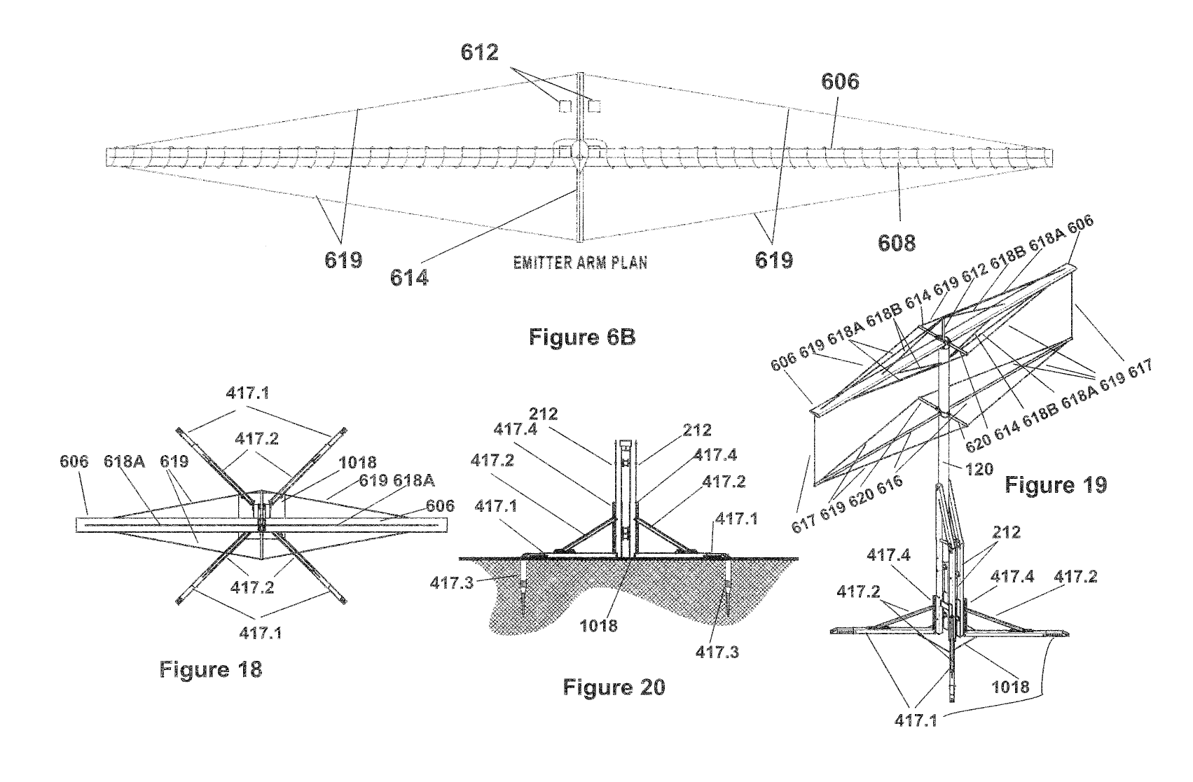

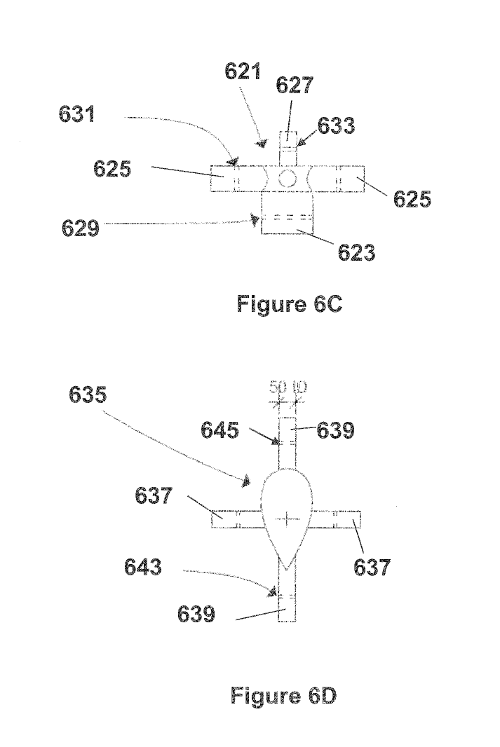

FIG. 6 depicts an emitter assembly 110 that is supported by the mast 120. The mast 120 and is generally vertical while the emitter assembly 110 is in operation. The mast 120 is a tube made from a glass reinforced fibre material, which has a cross section shaped to decrease the impact of wind force. The cross section is an aerofoil shape. Other shapes which are elongated in one direction can alternatively be used. Examples include but are not limited to an oval, a “D” shape, and a teardrop shape. The mast 120 is set up, so that it is oriented with the major axis being generally aligned to within +−16 degrees, with the prevailing wind direction, to minimise wind loading to the mast 120.

A high voltage cable 604 is provided inside the main arm 602, to energise the corona producing emitter assembly. Suitable power sources include, e.g. solar panels, a high voltage generator, and batteries. A backup internal combustion or high voltage generator is optionally included.

Referring to FIGS. 6A and 6B, at the top of the mast 120 are located one or more horizontal emitter arms 606. In the depicted embodiment, two emitter arms 606, extending in opposing diametric directions from the mast 120, form a wing structure. The two emitter arms 606 can alternatively be portions of a single emitter arm. The horizontal emitter arms 606 are also made from a glass reinforced plastic material. The entirety or at least a partial section of each emitter arm 606 has the same or similarly shaped cross section as the mast 120, extending out by about 4.5 metres from the mast 120. As they are supported atop the mast 120 when the mast 120 is upright, the emitter arms 606 are located at around 6 to 10 metres above ground in operation.

The emitter assembly 110 includes a vertical support bracket 612 extending from the top of the mast 120, with bracket 612 and arms 606 being secured to mast 120 by a pin or bracket 614 at the top of the mast 120. The pin 614 extends in both leeward and windward directions. A pair of horizontal field arms 616 (best seen in FIG. 3) are suspended at a height below the emitter arms 606 by stays 617 and by engaging the tube supports 637 (FIG. 6D), at around 60 to 75% of the total mast height. The horizontal field arms 616 extend in diametrically opposing directions from the mast 120, and can generally have the same lengths as the emitter arms 602. The two field arms 606 can alternatively be portions of a single field arm. The arms 616 are parallel to arms 606 and are collinear with them in the same vertical plane. The horizontal field arms 616 are also made from a glass reinforced plastic material, at a diameter of around 50 mm. Field wire, made from 0.5 mm diameter stainless steel wire, runs along the tops of the field arms 606, fixed at 200 to 300 mm centres. The field wire is energised at the same direct current polarity as the emitter filaments, at around −100 kV DC.

FIG. 6C depicts an emitter arm bracket 621 used to secure the emitter arm(s) 606 on the mast 120. The bracket 621 includes a mast sleeve 623 which is sized to fit onto the top end 111 of the mast 120. The bracket 621 further includes emitter arm sleeves 625 which are located, shaped and sized to receive the emitter arms 606. A top sleeve 627 is included to receive the vertical bracket 612. The sleeves 623, 625, 627 are made from 2 millimetre stainless steel. The sleeves 623, 625, 627 respectively include apertures 629, 631, 633 which will respectively align with corresponding passages in the mast 120, the emitter arms 606, and the top bracket 612. The aligned apertures 629, 631, 633 and passages receive locking pins which lock the mast 120, emitter arms 606, and top bracket 612 to the bracket 621 respectively. The locking pins can be 6 to 12 millimetres in diameter.

FIG. 6D depicts a field arm bracket 635 used to secure the field arm(s) 616 on the mast 120. The field arm bracket 635 includes sleeves 637 to receive the field arms 616, and sleeves 639 to receive the horizontal stay or bracing brackets 614. The field arm sleeves 637 each include apertures 643 which will align with a corresponding passage in the received field arm 616. The horizontal bracket sleeves 639 each include apertures 645 which will align with a corresponding passage in the received horizontal bracket 614. Locking pins are inserted through the apertures 645, 643 and into the respective passages to lock the horizontal brackets 614 and the field arms 616 in place. The locking pins are preferably 6 to 12 millimetres in diameter.

As shown in FIGS. 6, 6A, and 7, the horizontal emitter arms 606 include corona producing elements 608. The corona producing elements 608 comprises a loose bunch of stainless steel “hair”. Each hair has a diameter of about 6 to 12 microns. The stainless steel “hairs” together form a bunch that is several millimetres in diameter. The bunch 608 is wound around at least a portion of each emitter arm 606 in a helix pattern at approximately 50 to 100 mm centres, i.e. 50 to 100 mm separation between adjacent wounds, around the aerofoil or similarly shaped parts of the emitter arms 606. The field wires on the field arms 616 are straight. The cross section of the emitter arms 606, denoted by “D” in FIG. 7, has a horizontal major axis and a vertical minor axis. This shape increases the area of the corona elements which face upwards, to project ionising currents upwards.

As shown in FIGS. 3 and 6, the emitter arms 606 and field arms 616 are supported by insulated stabilising lines 618 that form a diamond shaped strut system. The insulated stabilising lines can be rigging ropes such as Spectra®, Vectran®, or equivalent ceramic rope so as to have a high dielectric contrast. The stabilising lines 618A, B, C and D extend from the vertical support bracket 612 and mast 120 so as to act as stays or struts to brace the emitter arms 606, at both the ends and an intermediate location of each, against upward and downward vertical forces which may result from turbulent wind. Not shown are horizontal stays 618 which brace the arms 606 in the fore and aft directions, by connecting the end and intermediate location of arms 606 to the fore and aft ends of the bracket or pin 614 (see FIG. 2). Stabilising lines 619 (shown in FIG. 6A) are also tethered to emitter arms 606 and the field arms 616. The support strut system provides vertical, horizontal, and diagonal support for the emitter assembly 110. Any appropriate rigging or support can be utilised as required which should have no conductive element in them and be made of low stretch insulating material.

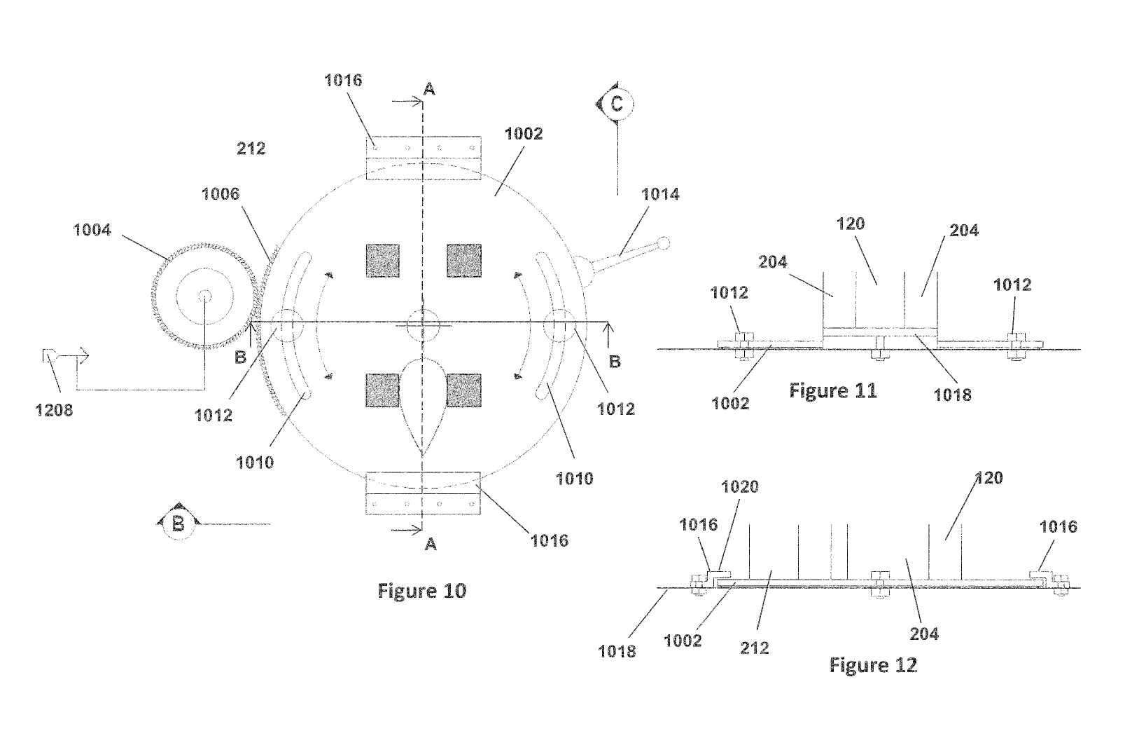

FIGS. 8 and 9 depict a movable platform 402 which is a part of a trailer 400 suitable for towing by a vehicle. However the platform 402 can alternatively be a part of the vehicle. An example layout of the platform 402 is shown in FIG. 8. The platform 402 includes dedicated areas to store the components or consumables required by the raising apparatus and ionising device. Examples include fuel storage 404, diesel storage 406, general storage 408, batteries 410, storage for communications or control equipment 412, storage for location detection equipment such as GPS. Raised side perimeters 414 help enclose the platform 412. The communications and control equipment can allow an operator to monitor and control the apparatus 200 if necessary, to e.g. rotate the ionization installation 100 about its vertical axis (e.g. see FIG. 10) in response to changes in wind direction, or to lower or raise the mast. The rotation is in the range of 0 to about 60 degrees. The dedicated areas are generally provided around the raising apparatus 200, which is located in a middle are of the platform 402. A gate 416 is provided in one of the raised sides 414 to allow access to the platform. When the raising apparatus 200 is set up, the second uprights or supports 212 will be located closer to the gate 416 than first uprights or supports 202 and mast 120. This allows an operator easier access to the winch mechanisms provided on the second uprights or supports 212, unencumbered by the intermediate posts or supports and mast 120. A rear area 418 adjacent the first uprights or supports 202 is kept clear, to allow the range of motion required by the intermediate posts or supports 204 which are hinged to the first uprights or supports 202, and also the range of motion of the mast 120 which is supported between the intermediate posts or supports 204. The mountings for the first uprights or supports 202 and second uprights or supports 212 can be rotatable about a vertical axis. The rotation can be driven by a motor. This way an operator either on site or off site can turn the mast if a change in the prevailing wind direction occurs.

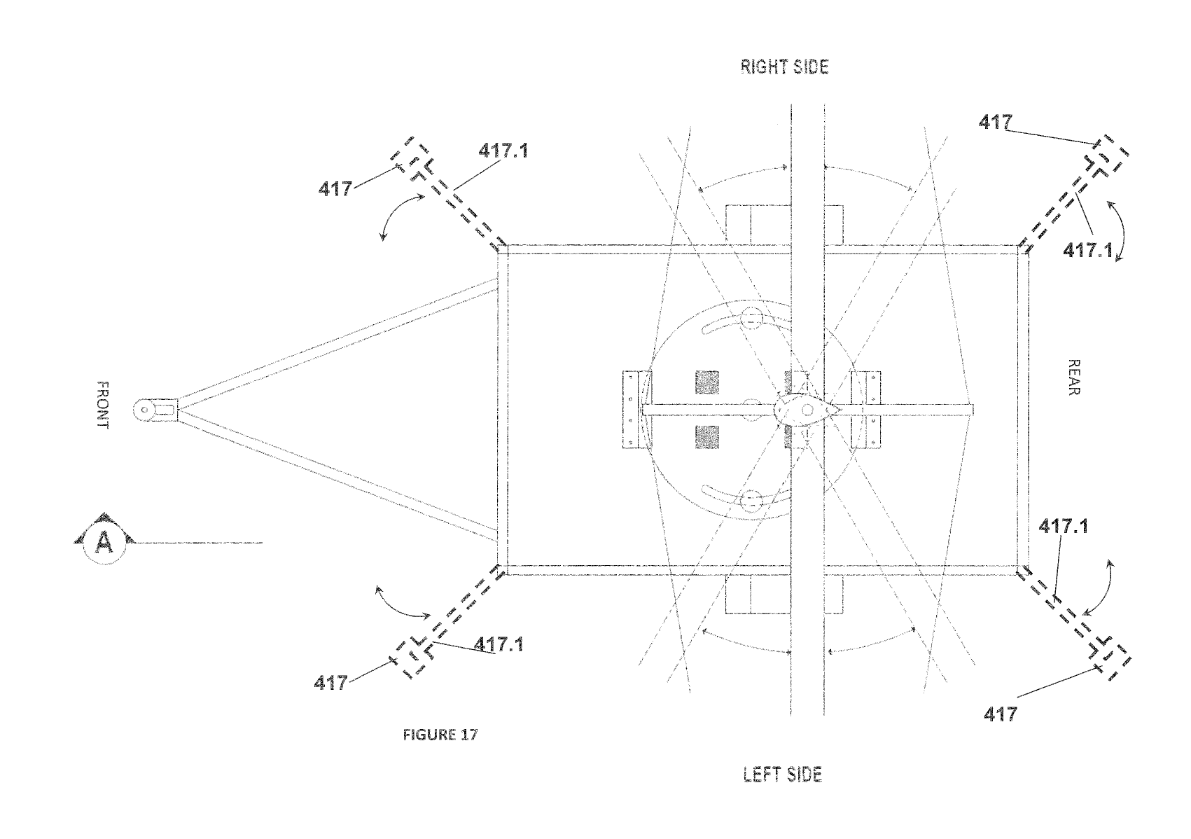

As shown in FIG. 9, the trailer 400 includes levelling feet 417 to help level the platform 402. The levelling feet 417 can include rubber pads or other insulators which assist to prevent the system grounding the ionisation installation 100. In the case of FIGS. 1 and 9 the levelling feet 417 are telescopically arranged in the hollow corner posts of the trailer. If desired the levelling feet 417, as illustrated in FIG. 17, can be telescopically arranged on outriggers 417.1 which are mounted for rotation to the trailer body. The outriggers 417.1 at the front of the trailer can be rotated frontwards and secured to the draw bar of the trailer, while at the rear of the trailer the outriggers 417.1 can be rotated to the rearward and secured to the rear of the trailer for transport/translocation purposes. If desired, the outriggers 417.1 at the front of the trailer can be of a length so as to reach near to the front of the draw bar when stowed, while the rear outriggers are preferably of a length that only reaches across the rear end of the trailer in the stowed condition. Alternatively the outriggers can be telescoping so that they can be extended when deployed and contracted when stowed.

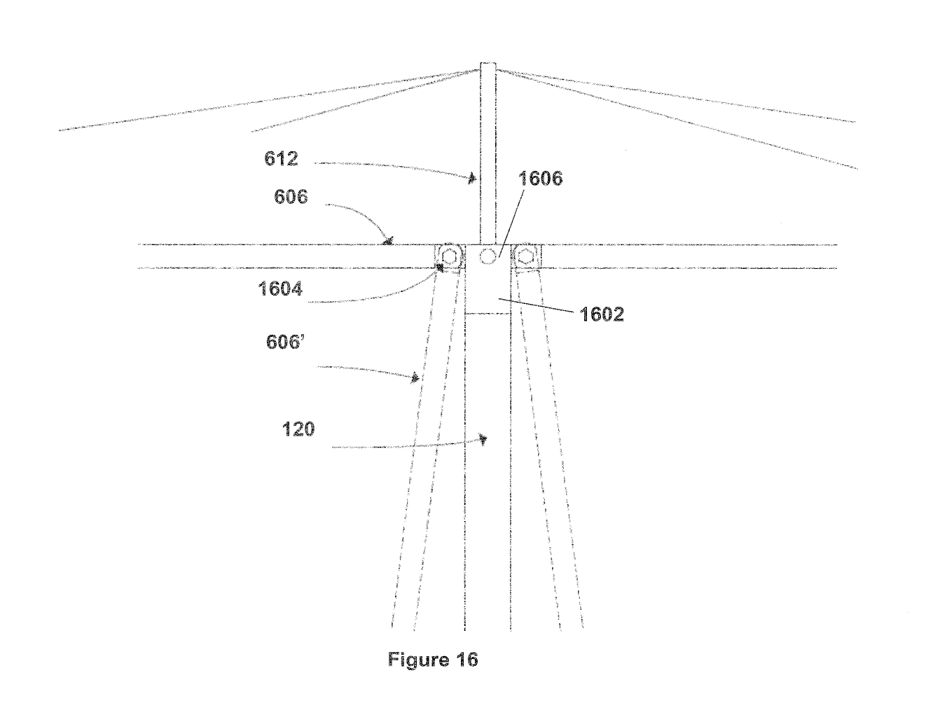

For transport, the intermediate posts or supports 212 are unhinged from the first uprights or supports 202. The first uprights or supports 202 may already be mounted on the platform 402 prior to transport or they may be mounted on site. The mast 120 and intermediate posts or supports 212 are rotated so that they are folded and placed in a horizontal orientation, and supported on top of the trailer within a transport rack 420. Components of the emitter assembly 110 are taken off the mast 120 and placed in the dedicated storage, or supported in the transport rack 420, and then assembled to the mast on site. Alternatively, emitter assembly 110 components such as the emitter arms 616, 606 and field arms, and the vertical or horizontal support brackets, are pivoted to the mast (see e.g. FIG. 16). The pivoted emitter assembly components are folded together and supported on the trailer, to be transported to the work site.

FIG. 10 depicts a base or platform which is or contains a rotating plate 1002 onto which the raising and support apparatus 200 can be mounted. The rotating plate 1002 is made from e.g. 20 to 25 millimetre plate and includes an at least partially geared perimeter. A master gear 1004 engages the gear teeth 1006 on the perimeter of the rotating plate 1002. The master gear 1004 is thus adapted to drive the rotating plate 1002. The master gear 1004 is driven by a motor, which receives control signals from a wind direction sensor 1008, so that the plate 1002 can be made to rotate in response to changes in the prevailing wind direction. In addition or alternative to the wind direction control, the motor which drives the gear 1004 can be controlled by an operator. FIG. 10 also depicts a lever 1014 which can be manually moved to turn the rotating base 1002. In this example, the lever is provided in addition to the geared control, to allow an operator to turn the emitter assembly manually. The motor drives or is dampened to complete the range of rotation required in 3 to 5 minutes on average, with suitable ‘dead band’ to mitigate short cycling.

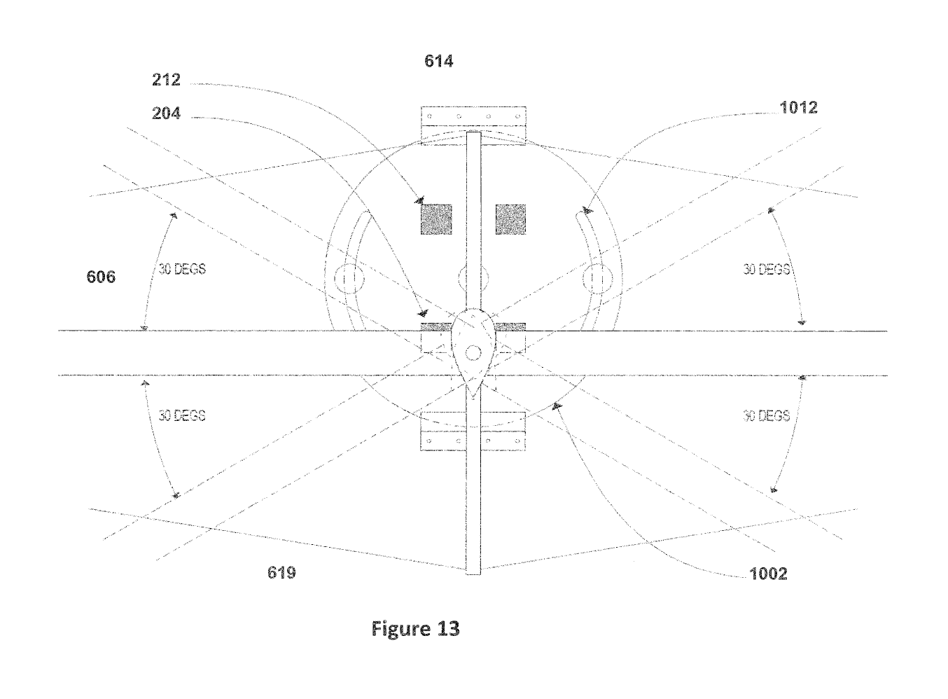

The motor is selected to allow bi-direction modulating motion of the gear 1004. As shown in FIG. 13, the rotating plate 1002 rotates by up to about 30 degrees in each direction, allowing for a total range of about 60 degrees. The motor can be controlled by a controller which has a built in rotation control which limits the range. Alternatively or additionally, a physical stop or anchor is provided to limit the range of rotation.

As shown in FIGS. 10 to 12, the rotating plate 1002 includes one or more anchoring slots or tracks 1010. In each slot or track there is located an anchor bolt or pin 1012. The anchoring track or slot 1010 is curved, so that as the plate 1002 is rotated, the slot 1010 moves relatively to the anchoring bolt or pin, until the rotation is stopped or until further movement is prevented by the edges of the anchoring track or slot 101. FIG. 17 depicts the resulting range of rotation of the emitter assembly, when it is mounted on a trailer which supports the rotating plate. A pair of retaining brackets or elements 1016 are bolted to the trailer or non-rotating part of the platform 1018. The retaining brackets 1016 each have a top flange 1020 located over an edge of the rotating plate 1002, to prevent the plate 1002 from lifting off the platform 1018.

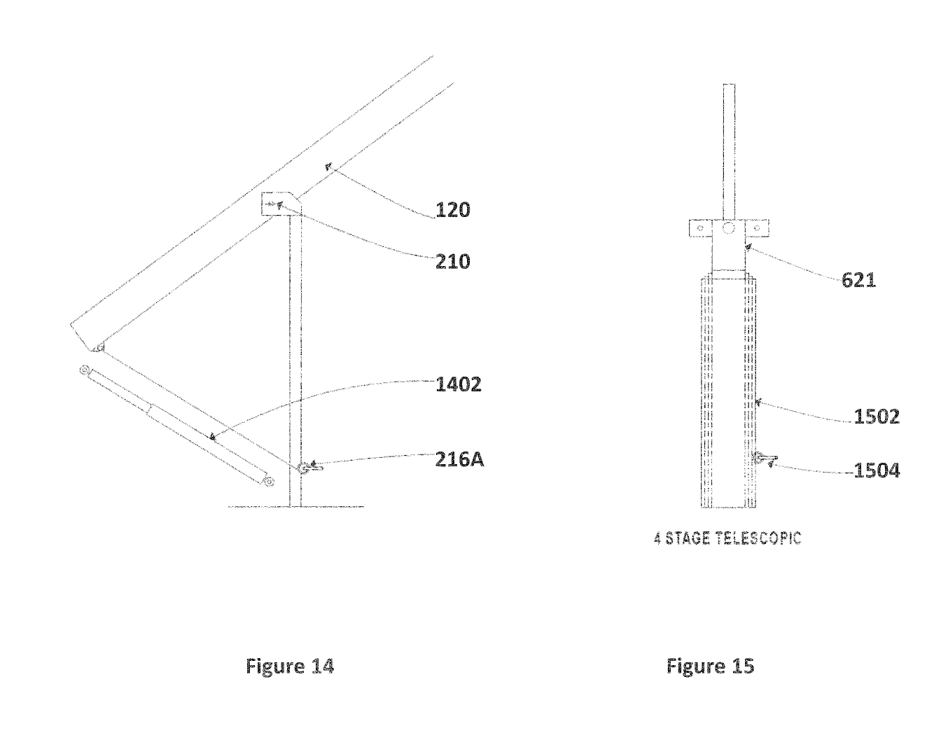

As shown in FIG. 14, either the first mechanism or arrangement for raising the intermediate post or support 204, or the second mechanism or arrangement for raising the mast 120, can include hydraulics. In this scenario, the first winch 214a, the second winch 216a, or both, is replaced by a hydraulic driving mechanism or cylinder 1402, which can be telescopic if need be.

As shown in FIG. 15, the mast 120 can be constructed from telescoping parts, instead of a single height system as described in the earlier embodiments. The telescoping parts are tubes 1502, which are arranged in a nested configuration to collapse the mast 120, or into an extended configuration to extend the mast height. The telescoping parts are driven by a winch 1504 or another driving mechanism into the collapsed or extended configuration.

FIG. 16 depicts an emitter assembly 110, where the emitter arms 606 can be folded toward the mast 120, to facilitate transportation. The emitter arms 606 are each attached to an emitter arm mounting 1602 which includes a correspondingly located hinged bracket 1604, to which the emitter arm is hinged or pivoted. The folded positions of the emitter arms 606 are depicted in dashed lines. The emitter arms 606 are raised from the folded configuration by pulling on the stabilising lines attached to the emitter arms 606.

Illustrated in FIGS. 18 to 20 is a ground located emitter assembly or ionisation installation 100, which is constructed in a similar manner as that described above in respect of earlier Figures. The difference being the supports 202 and 212 are mounted to, or assembled on, or welded to, a base plate or platform 1018 which rests on a ground location. The plate 1018 includes outriggers which formed from horizontal legs 417.1 to engage the ground and plate 1018 and vertical legs 417.4 for mounting to the supports 202 and 212, which are braced with respect to each other by means of the gusset or strut members 417.2. As depicted in FIG. 20, the ends of the horizontal legs 417.1 can be anchored to a ground location by means of ground engaging anchors 417.3. In FIG. 19, the upper half of this figure gives a perspective view of the construction of the emitter assembly 100 of earlier figures.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. An emitter assembly, comprising one or more emitter arms which extend from a main arm, each of said one or more emitter arms having at least a portion having a cross section which has a major axis and a minor axis, the major axis lying in a horizontal plane in use and the minor axis being in a vertical plane in use.

2. An emitter assembly as claimed in claim 1, wherein said one or more emitter arms extend generally horizontally in use.

3. An emitter assembly as claimed in claim 1, wherein said portion has a cross section of one of the following shapes: aerofoil, “D”, tear drop.

4. An emitter assembly as claimed in claim 1, further including a helical winding around said at least portion.

5. An emitter assembly as claimed in claim 4, wherein the helical winding comprises a plurality of strands of fibres which are bunched together.

6. An emitter assembly as claimed in claim 5, wherein said fibres are stainless steel fibres.

7. An emitter assembly as claimed in claim 5, wherein the fibres are each between approximately 6 and 12 microns in diameter.

8. An emitter assembly as claimed in claim 4, wherein said helical winding is wound around said one or more emitter arms at approximately 50 to 100 millimetre centres.

9. An emitter assembly as claimed in claim 1, having two emitter arms which extend in diametrically opposing directions from each other.

10. An emitter assembly as claimed in claim 1, further comprising a pair of horizontal field arms which extend from the main arm, in diametrically opposing directions from each.

11. An emitter assembly as claimed in claim 10, further comprising field wires running along the field arms.

12. An emitter assembly as claimed in claim 1, including horizontal support brackets extending from the main arm, and horizontal stabilising lines which run from free tips of the emitter arms to the horizontal support brackets.

13. An ionization device or installation, comprising an emitter assembly as claimed in claim 1;
a mast which supports the emitter assembly; and
a raising apparatus which raises the mast to an upright position in articulated stages.

14. An ionization device or installation as claimed in claim 13, wherein at least a section of said mast has a cross section of one of the following shapes: aerofoil, “D”, tear drop.

15. An ionization device or installation as claimed in claim 13, wherein the one or more emitter arms of the emitter assembly are pivotable relative to the mast.

16. An ionization device as claimed in claim 1, wherein the one or more emitter arms of the emitter assembly are detachable from the mast.

17. An ionization device or installation as claimed in claim 13, wherein there is included an apparatus for erecting the mast, comprising
at least one first support that is supported on a base;
at least one intermediate support that is pivotable relative to the first support at a first pivot, the first pivot being located at or near a first end of the intermediate support;
the mast being pivotably supported by said intermediate support at a second pivot, the second pivot being located in a lower or intermediate portion of the mast when the mast is in a substantially upright position.

18. An ionization device or installation as claimed in claim 17, comprising two of said first supports and two of said intermediate supports, wherein one first support and one intermediate support are placed on one side of said mast, and the other first support and intermediate support are placed on an opposing side of said mast, wherein said first support includes a yoke which supports said mast.

19. (canceled)

20. An ionization device or installation as claimed in claim 17, further comprising a second support located adjacent the first support; the second support supporting an arrangement for raising the intermediate post at the first pivot, wherein said second support supports an arrangement for pivoting the mast about the second pivot.

21. (canceled)

22. An ionization device or installation as claimed in claim 20, wherein the arrangement for raising the intermediate post is a first winch means, said base is one of a transportable base, a mobile base, and a stationary base, a field wire being located at 70% to 75% of the height of the mast from the base.

23-35. (canceled)
